(19) United States
(12) Patent Application Publication
(10) Pub. No.: US 2017/0332396 A1
(43) Pub. Date: Nov. 16, 2017

(54) Unified and Scalable Frame Structure for OFDM System

(71) Applicant: MEDIATEK INC., Hsinchu (TW)

(72) Inventors: Pei-Kai Liao, Nantou Country (TW); Xiu-Sheng Li, Taipei City (TW); Wei-Jen Chen, Taipei City (TW)

(21) Appl. No.: 15/593,324

(22) Filed: May 12, 2017

Related U.S. Application Data
(60) Provisional application No. 62/335,837, filed on May 13, 2016.

(51) Int. Cl. H04W 72/12; H04L 27/26; H04W 72/04; H04L 5/14

(52) U.S. Cl. CPC H04W 72/1268; H04W 72/1273; H04W 72/042; H04L 27/2607; H04L 5/14

(57) ABSTRACT

A unified frame structure is scalable to meet the 5G new radio requirements, to support flexible TDD configurations, to support multiple numerologies, and to adapt to the channel properties of different spectrums up to 100 GHz. Multiple numerologies with 15 KHz subcarrier spacing and its integer or 2^{m} multiple are proposed, where m is a positive integer. Under the unified frame structure, each radio frame is a basic operation time unit in higher layer and comprises a plurality of slots, and each slot within a radio frame is a basic scheduling time unit in physical layer and comprises a predefined number of OFDM symbols. A semi-static configuration configures DL-only slot type via system information or higher-layer signaling, while a physical layer signaling is used to dynamically configure flexible slot types.

### CROSS REFERENCE TO RELATED APPLICATIONS

This application claims priority under 35 U.S.C. §119 from U.S. Provisional Application No. 62/335,837, entitled “Scalable Frame Structure for OFDM System,” filed on May 13, 2016, the subject matter of which is incorporated herein by reference.

### TECHNICAL FIELD

The present invention relates generally to wireless communication systems and, more particularly, to flexible frame structure for OFDM systems.

### BACKGROUND

In wireless communication systems, such as defined by 3GPP Long Term Evolution (LTE/LTE-A) specification, user equipments (UE) and base stations (eNodeB) communicate with each other by sending and receiving data carried in radio signals according to a predefined radio frame format. Typically, the radio frame format contains a sequence of radio frames, each radio frame having the same frame length with the same number of subframes. The subframes are configures to perform uplink (UL) transmission or downlink (DL) reception in different Duplexing methods. Time-division duplex (TDD) is the application of time-division multiplexing to separate transmitting and receiving radio signals. TDD has a strong advantage in the case where there is asymmetry of the uplink and downlink data rates. Several different TDD configurations are provided in LTE/LTE-A systems to support different DL/UL traffic ratios for different frequency bands.

The different TDD UL-DL configurations provide 40% to 90% DL subframes, and is broadcasted in the system information block, i.e. SIB1. The semi-static allocation via SIB1, however, may or may not match the instantaneous traffic situation. Currently, the mechanism for adapting UL-DL allocation is based on the system information change procedure. In 3GPP LTE Rel-11 and after and 4G LTE, the trend of the system design shows the requirements on more flexible configuration in the network system. Based on the system load, traffic type, traffic pattern and so on, the system can dynamically adjust its parameters to further utilize the radio resource and to save the energy. One example is the support of dynamic TDD configuration, where the TDD configuration in the system may dynamically change according to the DL/UL traffic ratio.

The Next Generation Mobile Network (NGMN) Board, has decided to focus the future NGMN activities on defining the end-to-end (E2E) requirements for 5G. Three main applications in 5G include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Specifically, the design requirements for 5G includes maximum cell size requirements and latency requirements. The maximum cell size is urban micro cell with inter-site distance (ISD)=500 meters, i.e. cell radius is 250-300 meters. For eMBB, the E2E latency requirement is <=10 ms; for URLLC, the E2E latency is <=1 ms. Furthermore, multiplexing of eMBB & URLLC within a carrier should be supported, and TDD with flexible UL/DL ratio is desirable. Under the existing LTE TDD frame structure, which subframe can be UL or DL is fixed within a radio frame. Even under dynamic TDD configuration, the TDD configuration can only change every 10 ms (one radio frame). Such latency performance obviously cannot meet the 5G requirements.

Orthogonal Frequency Division Multiplexing (OFDM) is an efficient multiplexing scheme to perform high transmission rate over frequency selective channel without the disturbance from inter-carrier interference. In LTE OFDM systems, resource allocation is based on a regular time-frequency grid. OFDM symbols with the same numerology are allocated across the whole time-frequency grid. 5G new radio may require multiple numerologies to support spectrum up to 100 GHz due to the following considerations: phase noise, Doppler spread, channel delay spread and other practical considerations (e.g., synchronization timing error). Multiple numerologies with 15 KHz subcarrier spacing and its integer or 2^{m} multiple are proposed, where m is a positive integer. For example, in a unified frame structure design, there are 14/12 OFDM symbols in a subframe using normal/extended cyclic prefix in each numerology. The supported subcarrier spacing can be 15 KHz, 30 KHz, 60 KHz, 120 KHz, and 240 KHz.

A new unified and scalable frame structure is sought to meet the 5G NR requirements, to support flexible TDD configurations, to support multiple numerologies, and to adapt to the channel properties of different spectrums up to 100 GHz.

### SUMMARY

A unified radio frame structure for both frequency division duplex (FDD) and time division duplex (TDD) is proposed. The unified frame structure is scalable to meet the 5G new radio requirements, to support flexible TDD configurations, to support multiple numerologies, and to adapt to the channel properties of different spectrums up to 100 GHz. Multiple numerologies with 15 KHz subcarrier spacing and its integer or 2^{m} multiple are proposed, where m is a positive integer. Under the unified frame structure, each radio frame is a basic operation time unit in higher layer and comprises a plurality of slots, and each slot within a radio frame is a basic scheduling time unit in physical layer and comprises a predefined number of OFDM symbols. A semi-static configuration configures DL-only slot type via system information or higher-layer signaling, while a physical layer signaling is used to dynamically configure flexible slot types.

In one embodiment, a UE receives a higher layer configuration from a base station in a mobile communication network. The UE exchanges data with the base station according to a predefined radio frame format, and each radio frame comprises a plurality of slots. The higher layer configuration indicates which slots are downlink-only (DL-only) slots and which slots are flexible slots. The UE detects a physical layer signaling that indicates one or more slot types associated with corresponding one or more flexible slots of each radio frame. The UE determines the one or more slot type of the one or more flexible slots based on the higher layer configuration and the physical layer signaling.

In another embodiment, a base station transmits a higher layer configuration to a user equipment (UE) in a mobile communication network. The base station exchanges data with the UE according to a predefined radio frame format, and each radio frame comprises a plurality of slots. The higher layer configuration indicates which slots are downlink-only (DL-only) slots and which slots are flexible slots. The base station transmits a physical layer signaling to indicate one or more slot types associated with corresponding one or more flexible slots of each radio frame. The base station performs data transmission and/or reception with the UE in the flexible slots based on the indicated slot type.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a unified and scalable radio frame structure supporting multiple numerologies in 5G new radio systems in accordance with one novel aspect.

FIG. 2 is a simplified block diagram of a user equipment and a base station with flexible radio frame structure in accordance with one novel aspect.

FIG. 3 illustrates the different slot types defined in 5G NR systems.

FIG. 4 illustrates a first embodiment of physical signaling indicating slot type.

FIG. 5 illustrates a second embodiment of physical signaling indicating slot type.

FIG. 6 illustrates a third embodiment of physical signaling indicating slot type.

FIG. 7 illustrates one embodiment of flexible TDD configuration based on semi-static configuration broadcasted or unicasted by the base station.

FIG. 8 illustrates one embodiment of flexible TDD configuration indicating a number of OFDM symbols reserved for guard period.

FIG. 9 is a sequence flow between a base station and UEs for dynamically changing frame structure based on current system needs.

FIG. 10 is a flow chart of a method of dynamically configuring slot type with flexible frame structure from UE perspective in accordance with one novel aspect.

FIG. 11 is a flow chart of a method of dynamically configuring slot type with flexible frame structure from eNB perspective in accordance with one novel aspect.

### DETAILED DESCRIPTION

Reference will now be made in detail to some embodiments of the invention, examples of which are illustrated in the accompanying drawings.

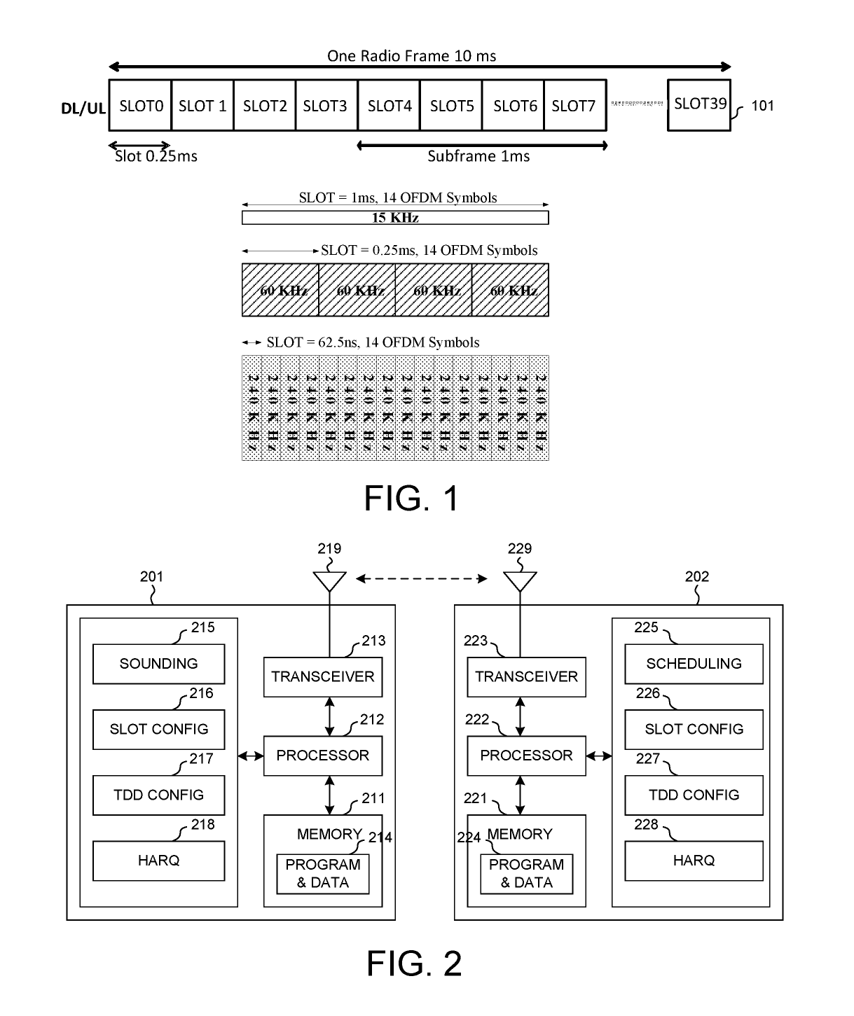

FIG. 1 illustrates a unified and scalable radio frame structure supporting multiple numerologies in 5G new radio systems in accordance with one novel aspect. The Next Generation Mobile Network (NGMN) Board, has decided to focus the future NGMN activities on defining the end-to-end (E2E) requirements for 5G. Three main applications in 5G include enhanced Mobile Broadband (eMBB), Ultra-Reliability & Low Latency Communications (URLLC), and massive Machine-Type Communications (mMTC) considering spectrum up to 100 GHz for both licensed and unlicensed frequency bands. Specifically, the performance requirements for 5G include peak data rate and latency requirements. For eMBB, the target of peak data rate is 20 Gbps in downlink and 10 Gbps in uplink. For eMBB, the E2E latency requirement is <=10 ms; for URLLC, the E2E latency is <=1 ms. However, under the existing LTE TDD frame structure, the latency performance cannot meet the 5G performance requirements. Further, 5G new radio (NR) require multiple numerologies to support spectrum up to 100 GHz due to the following considerations: phase noise, Doppler spread, channel delay spread and other practical considerations (e.g., synchronization timing error).

In accordance with one novel aspect, a new unified and scalable frame structure is proposed to meet the 5G NR requirements, to support flexible time division duplex (TDD) configurations, to support multiple numerologies, and to adapt to the channel properties of different spectrums up to 100 GHz. Multiple numerologies with 15 KHz subcarrier spacing and its integer or 2^{m} multiple are proposed, where m is a positive integer. For example, the supported subcarrier spacing can be 15 KHz, 30 KHz, 60 KHz, 120 KHz, and 240 KHz. In the unified frame structure, the definition of a radio frame is the basic operation time unit in higher layer. The radio frame is defined as a fixed time length, e.g., 10 ms or 5 ms for all supported numerologies. Each radio frame in turn consists of a plurality of slot, the definition of a slot is the basic scheduling time unit in physical layer. The slot is defined as a fixed number of OFDM symbols, e.g., 14 OFDM symbols or 7 OFDM symbols for all supported numerologies.

In the example of FIG. 1, with 60 KHz subcarrier spacing, a radio frame 101 consists of 10 subframes and 40 slots. The time length of a radio frame is 10 ms, the time length of a subframe is 1 ms, and the time length for a slot is 0.25 ms, i.e., 14 OFDM symbols. Keeping 10 ms radio frame length to be the same as LTE can maximize the potential protocol stacks sharing between LTE and 5G and simplify the design of 5G-LTE interworking. For example, UE does not need to obtain 5G system frame number for RACH resources during handover from LTE cell to 5G cell. On the other hand, defining each slot to have a fixed number of OFDM symbols helps to simplify implementation of physical layer functionalities including pilot transmission and channel estimation. As depicted in FIG. 1, the slot length for 15 KHz subcarrier spacing is 1 ms, the slot length for 60 KHz subcarrier spacing is 0.25 ms, and the slot length for 240 subcarrier spacing is 62.5 ns. For all numerologies, although the slot length is different, each slot contains a fixed number of 14 OFDM symbols. The frame structure of radio frame 101 can be applied to both frequency division duplex (FDD) and TDD systems.

When the 5G NR system supports multiple numerology sets, a UE can blindly detect the OFDM symbol time length and determine the slot time length based on the detection results and the slot definition (e.g., number of OFDM symbols per slot). In a first option, the OFDM symbol time length can be done by the detection of cyclic prefix time length. In a second option, the OFDM symbol time length can be done by the detection of a common pilot in time domain. In a third option, the OFDM symbol time length can be done by the detection of cyclic prefix time length and a common pilot in frequency domain.

FIG. 2 is a simplified block diagram of a user equipment UE 201 and a base station eNB 202 with flexible FDD and TDD radio frame structure in accordance with one novel aspect. UE 201 comprises memory 211, a processor 212, an RF transceiver 213, and an antenna 219. RF transceiver 213, coupled with antenna 219, receives RF signals from antenna 219, converts them to baseband signals and sends them to processor 212. RF transceiver 213 also converts received baseband signals from processor 212, converts them to RF signals, and sends out to antenna 219. Processor 212 processes the received baseband signals and invokes different functional modules and circuits to perform features in UE 201. Memory 211 stores program instructions and data 214 to control the operations of UE 201. The program instructions and data 214, when executed by processor 212, enables UE 201 to receive higher layer and physical layer configuration for each slot and to exchange DL/UL control/data with its serving base station based on the configured slot type.

Similarly, eNB 202 comprises memory 321, a processor 222, an RF transceiver 223, and an antenna 229. RF transceiver 223, coupled with antenna 229, receives RF signals from antenna 229, converts them to baseband signals and sends them to processor 222. RF transceiver 223 also converts received baseband signals from processor 222, converts them to RF signals, and sends out to antenna 229. Processor 222 processes the received baseband signals and invokes different functional modules and circuits to perform features in eNB 202. Memory 221 stores program instructions and data 224 to control the operations of eNB 202. The program instructions and data 224, when executed by processor 222, enables eNB 202 to configure slot type via higher layer and physical layer signaling and to exchange DL/UL control/data with its served UEs based on the configured slot type.

UE 201 and eNB 202 also comprise various function modules and circuits that can be implemented and configured in a combination of hardware circuits and firmware/software codes being executable by processors 212 and 222 to perform the desired functions. In one example, UE 201 comprises a sounding module 215 that performs uplink sounding for MIMO channel state information measurement, a slot configuration circuit 216 that configures slot type dynamically for 5G systems, a TDD configuration module 217 that determines adaptive TDD configuration for LTE systems, and an HARQ circuit 218 for HARQ and feedback operation. Similarly, eNB 202 comprises a scheduling module 225 that provides downlink scheduling and uplink grant, a slot configurator 226 that configures slot type dynamically for 5G systems, a TDD configuration module 227 that determines adaptive TDD configuration for LTE systems, and an HARQ circuit 228 for HARQ and feedback operation.

To facilitate flexible TDD configuration, each slot within a radio frame has a flexible slot type, which can be semi-statically and dynamically configured as one of the supported slot types. As a basic scheduling unit, each slot can be indicated to a UE by the base station via higher layer signaling and DL physical layer signaling so that the slot type in each slot can be changed semi-statically and dynamically based on current system needs to support different DL/UL ratios and meet 5G latency requirements. The higher layer and the physical layer signaling can be a broadcast, multi-cast or unicast signaling. The physical layer signaling can be same-slot indication (i.e. physical layer signaling in slot N indicates the slot type of slot N) or cross-slot indication (i.e. physical layer signaling in slot N indicates the slot type of slot N+K, where K≧1).

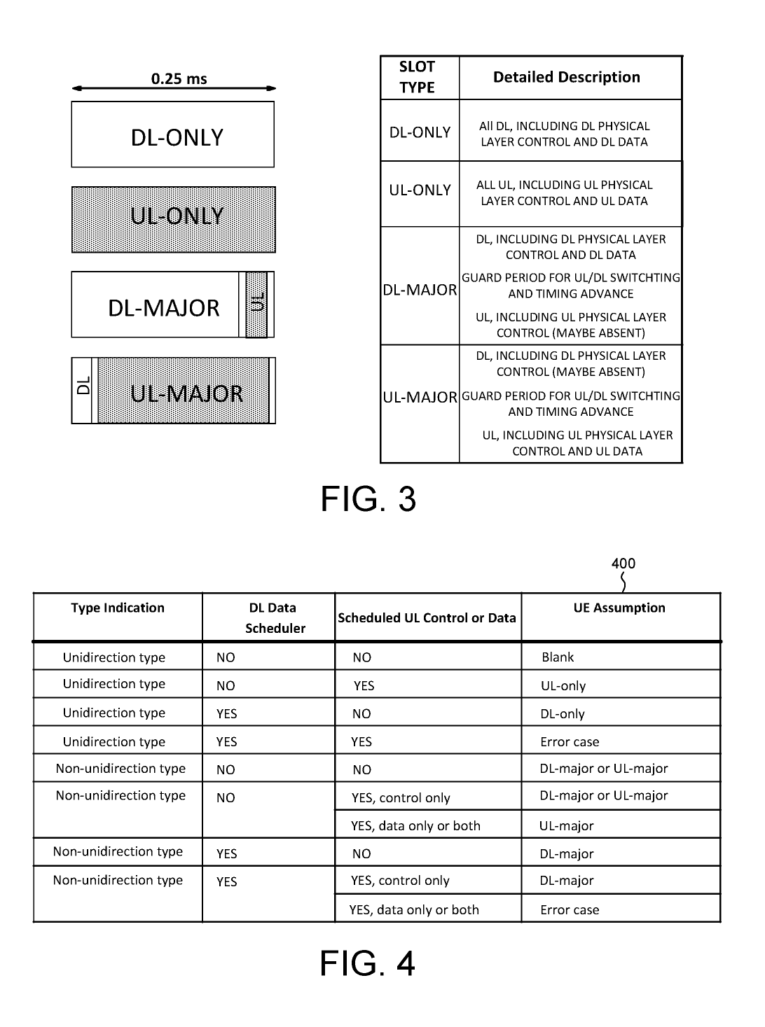

FIG. 3 illustrates an example with four different slot types defined in 5G NR systems. The following four slots types can be dynamically configured: slot type 1 with all DL (referred to as DL-only), slot type 2 with all UL (referred to as UL-only), slot type 3 with more DL & less UL (referred to as DL-major), and slot type 4 with more UL & less DL (referred to as UL-major). The basic scheduling unit and the basic transmission time interval (TTI) is one slot length. When multiple slots are aggregated, the TTI can be larger than one slot length. In this example, same-slot indication is assumed for the DL PHY layer signaling indicating slot type.

For DL-only slot type, all OFDM symbols of the entire slot is for DL transmission, which includes both DL data and DL control. For UL-only slot type, all OFDM symbols of the entire slot is for UL transmission, which includes both UL data and UL control. For DL-major slot type, there are both DL part (including either DL data only or DL data with DL control) and UL part (including UL control) in the slot. DL-major slot type can be allocated when there is DL data and several blank OFDM symbols in the end of the slot are need for other purposes, e.g., larger guard period, listen-before-talk. For UL-major slot type, there are DL part (including DL control) and UL part (including either UL data only or UL data with UL control) in the slot. UL-major slot type can be allocated when there is UL data and several blank OFDM symbols in the beginning of the slot are needed for other purposes, e.g., larger guard period, listen-before-talk. The GP length is 17.84/20.84 μs, assuming 60 KHz subcarrier spacing, which is sufficient to accommodate UE DL-to-UL switching time, UL-to-DL switching time and UL timing advance. For larger subcarrier spacing, e.g. 120 KHz and 240 KHz, more OFDM symbols are needed for GP to accommodate DL-to-UL switching time, UL-to-DL switching time, and UL timing advance. The number of OFDM symbols reserved for guard period for DL-major and UL-major is configurable.

FIG. 4 illustrates a first embodiment of physical signaling indicating slot type. In the first embodiment, the physical-layer signaling is used to indicate unidirection or non-unidirection slot type. The physical-layer signaling can be via PDCCH or via another physical channel, it can be same slot indication or cross-slot indication. In general, when the indication is combined with DL and UL scheduler, the UE is able to deduce the slot type accordingly. In one example, the indication is just one-bit, indicating the slot type is either unidirection, e.g., either DL-only or UL-only, or the slot type is non-unidirection, e.g., either DL-major or UL-major. Table 400 depicts all possible indications combined with DL data scheduler and scheduled UL control or data, under which the UE can deduce the slot type. The first column of Table 400 indicates whether the slot type is unidirection or non-unidirection, the second column of Table 400 indicates whether the slot has scheduled DL data, the third column of Table 400 indicates whether the slot has scheduled UL control or data. In a few cases, however, there might be error case due to decoding error or due to an unsupported feature.

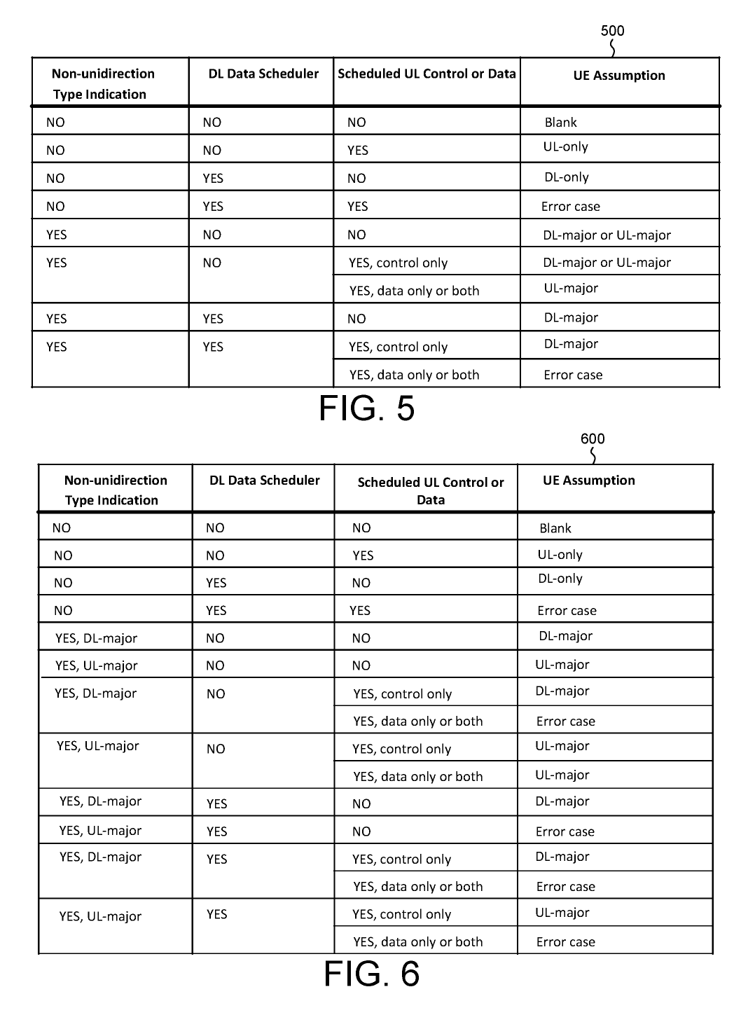

FIG. 5 illustrates a second embodiment of physical signaling indicating slot type. In the second embodiment, the physical-layer signaling is used to indicate non-unidirection slot type only. The physical-layer signaling can be via PDCCH or via another physical channel, it can be same slot indication or cross-slot indication. In general, when the indication is combined with DL and UL scheduler, the UE is able to deduce the slot type accordingly. In one example, the indication is to use one-bit to indicate the slot type is non-unidirection, e.g., either DL-major or UL-major. If the slot type is unidirection, e.g., DL-only or UL-only, then no indication is used, e.g., no physical-layer signaling is necessary. Table 500 depicts all possible indications combined with DL data scheduler and scheduled UL control or data, under which the UE can deduce the slot type. The first column of Table 500 indicates whether the slot type is non-unidirection, the second column of Table 500 indicates whether the slot has scheduled DL data, the third column of Table 500 indicates whether the slot has scheduled UL control or data. In a few cases, however, there might be error case due to decoding error or due to an unsupported feature.

FIG. 6 illustrates a third embodiment of physical signaling indicating slot type. In the third embodiment, the physical-layer signaling is used to indicate DL-major or UL-major slot type. The physical-layer signaling can be via PDCCH or via another physical channel, it can be same slot indication or cross-slot indication. In general, when the indication is combined with DL and UL scheduler, the UE is able to deduce the slot type accordingly. In one example, the indication is just one-bit, indicating the slot type is either DL-major or UL-major. If the slot type is unidirection, e.g., DL-only or UL-only, then no indication is used. Table 600 depicts all possible indications combined with DL data scheduler and scheduled UL control or data, under which the UE can deduce the slot type. The first column of Table 600 indicates whether the slot type is DL-major or UL-major, the second column of Table 600 indicates whether the slot has scheduled DL data, the third column of Table 600 indicates whether the slot has scheduled UL control or data. In a few cases, however, there might be error case due to decoding error or due to an unsupported feature. The indication of DL-major or UL-major slot type enables explicit indication of UL control channel type if there are two different UL control channel types for DL-major and UL-major slot types. Two different UL control channel types are very useful to support both power-limited and non-power-limited UEs when the serving cell size is large.

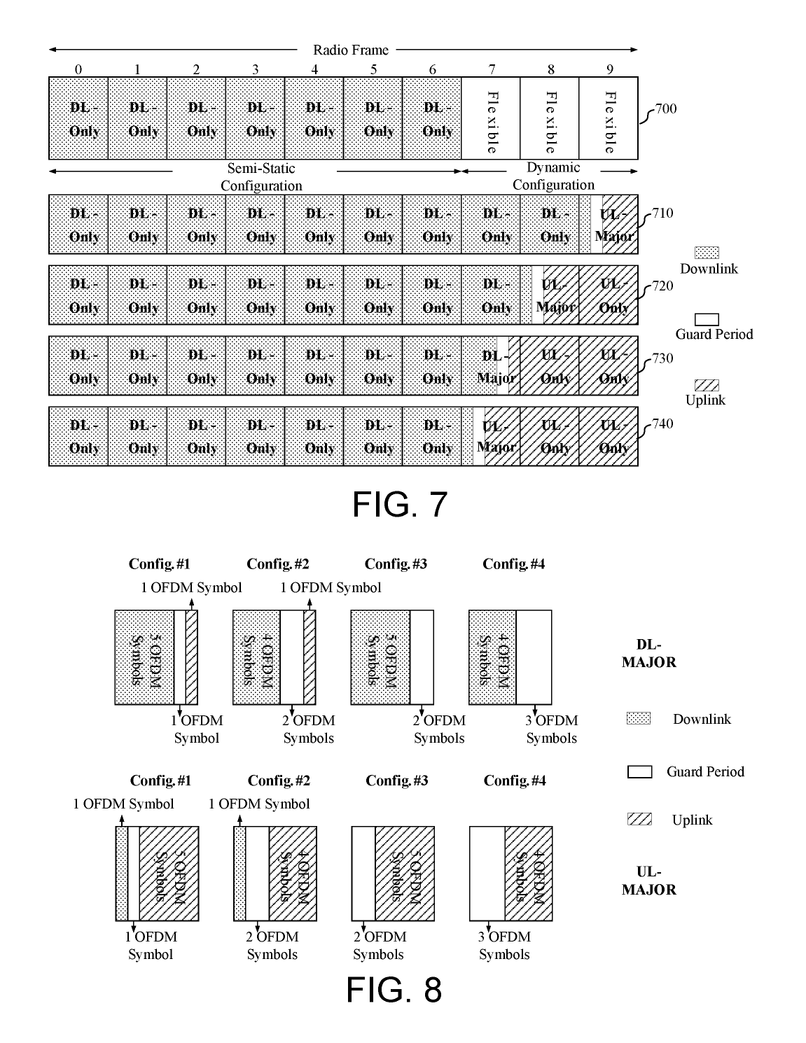

FIG. 7 illustrates one embodiment of flexible TDD configuration based on semi-static configuration broadcasted or unicasted by the base station. In one novel aspect, semi-static configuration regarding to which slots are DL-only and which slots are flexible within a radio frame is proposed. The semi-static configuration can be broadcasted in the system information, or unicasted to a UE via higher-layer signaling when the system information update happens. The reasons for such semi-static configuration is as follows: 1) it reduces system performance impact due to inter-BS interface. This is because DL data transmission introducing larger inter-BS interference for cell-edge UEs can be allocated in the semi-statically configured DL-only slots, and DL data transmission introducing small inter-BS interference can be allocated in the dynamically allocated DL-only subframes. 2) it reduces the efforts for a UE to detect and decode dynamic slot type indication; 3) it provides a reference for a UE to perform synchronization tracking on common pilots and channel state information (CSI) measurements on CSI pilots. The slot type of flexible slots can be indicated to a UE by same-slot or cross-slot physical-layer signaling. For example, the slot type of flexible slots can be indicated to a UE by the physical-layer signaling transmitted at the beginning of a radio frame (e.g. first N slots of a radio frame, where N≧1).

As depicted in FIG. 7, a radio frame 700 contains 10 slots, with 15 KHz subcarrier spacing. Radio frame 700 is configured to have the first seven slots as DL-only slots, and the next three slots as flexible slots under semi-static configuration. A DL-only slot is semi-statically configured to be DL-only slot type. A flexible slot is a slot that can have any slot type, and can be dynamically configured by the base station via physical-layer signaling. A UE needs to detect and decode the slot type for flexible slots only by combining semi-static configuration and physical-layer signaling, e.g., the UE knows slots 0-6 are DL-only slot type, and detects and decodes slots 7-9 dynamically. For example, radio frame 710 has the first 9 slots to be DL-only, and slot#9 to be UL-major; radio frame 720 has the first 8 slots to be DL-only, slot#8 to be UL-major, and slot#9 to be UL-only; radio frame 730 has the first 7 slots to be DL-only, slot#7 to be DL-major, slot#8 to be UL-only, and slot#9 to be UL-only; radio frame 740 has the first 7 slots to be DL-only, slot#7 to be UL-major, slot#8 to be UL-only, and slot#9 to be UL-only.

FIG. 8 illustrates one embodiment of flexible TDD configuration indicating a number of OFDM symbols reserved for guard period. The guard period (GP) in DL-major or UL-major slot type can be broadcasted in the system information, and can also be unicasted to a UE via higher-layer signaling when system information update happens. The reasons for such configuration is as follows: 1) it enables the support of larger cell deployments because large guard period can accommodate larger UL timing advance; and 2) it allows the support of UEs with larger RF switching time.

As depicted in FIG. 8, for a DL-major slot with seven OFDM symbols, there are four different configurations for guard period. In Config#1, one OFDM symbol is reserved for guard period, and one OFDM for UL. In Config#2, two OFDM symbols are reserved for guard period, and one OFDM symbol for UL. In Config#3, two OFDM symbols are reserved for guard period, and none for UL. In Config#4, three OFDM symbols are reserved for guard period, and none for UL. Similarly, for an UL-major slot with seven OFDM symbols, there are four different configurations for guard period. In Config#1, one OFDM symbol is reserved for guard period, and one OFDM for DL. In Config#2, two OFDM symbols are reserved for guard period, and one OFDM symbol for DL. In Config#3, two OFDM symbols are reserved for guard period, and none for DL. In Config#4, three OFDM symbols are reserved for guard period, and none for DL.

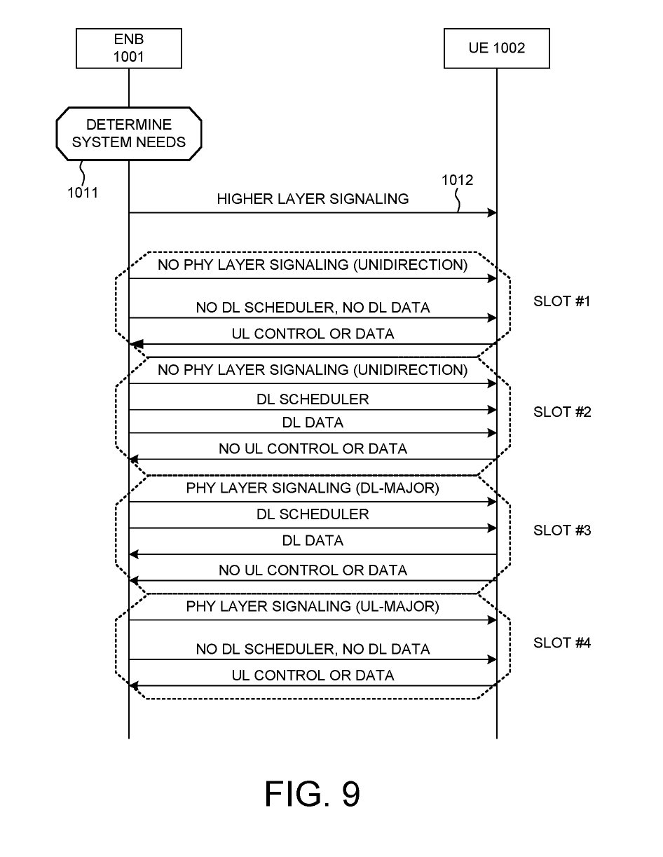

FIG. 9 is a sequence flow between a base station and UEs for dynamically changing frame structure based on current system needs. In step 1011, eNB 1001 determines the current system needs, e.g., DL/UL radio, latency requirements, inter-BS interference, etc. and thereby determining the subsequent slot types accordingly. In step 1012, eNB 1001 transmits a higher layer signaling to UE 1002, for semi-static configuration of the slot types, e.g., which slots are DL-only and which slots are flexible and needs to be dynamically configured by eNB via physical layer signaling. In addition, the higher layer signaling may also indicate the number of OFDM symbols reserved for GP in DL-major and UL-major slots.

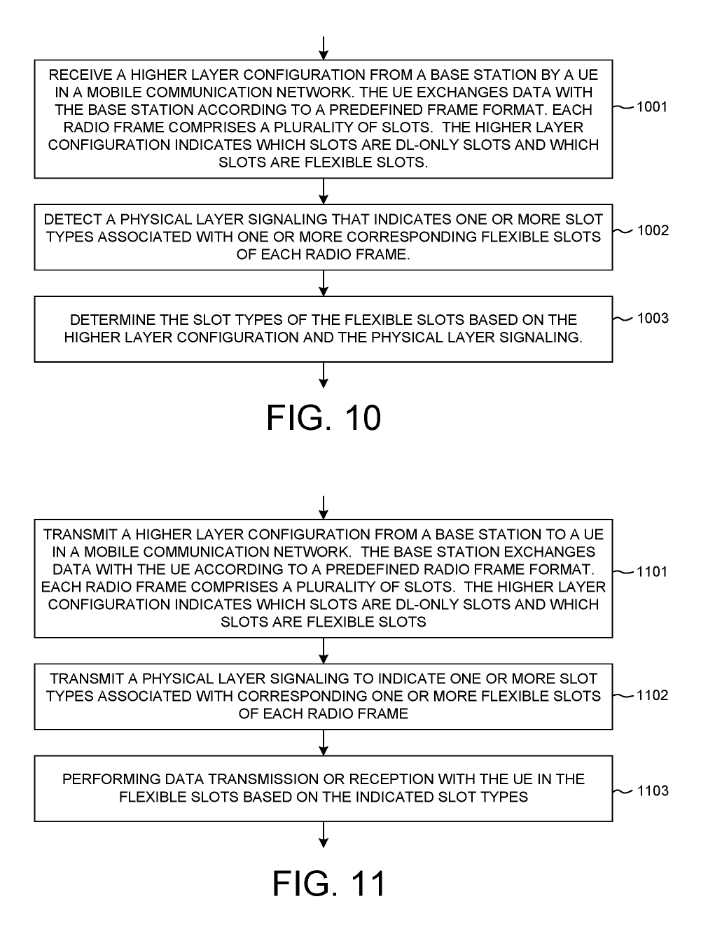

For the flexible slot types, eNB 1001 configures via physical-layer signaling. In the example of FIG. 10, same-slot indication is assumed for the DL PHY layer signaling indicating slot type. Further assume that the DL PHY layer signaling is used to indicate DL-major or UL-major slot type, and no PHY layer signaling is used for DL-only or UL-only unidirectional slot type. In slot#1, UE 1002 detects no slot type PHY signaling, inferring the slot type is unidirectional, e.g., either DL-only or UL-only. In addition, there is no DL scheduler and DL data in slot#1, while there is scheduled UL control or data. As a result, UE 1002 knows that slot#1 is of UL-only slot type. In slot#2, UE 1002 detects no slot type PHY signaling, inferring the slot type is unidirectional, e.g., either DL-only or UL-only. In addition, UE 1002 detects a DL scheduler and DL data in slot#2, while there is no scheduled UL control or data. As a result, UE 1002 knows that slot#2 is of DL-only slot type. In slot#3, eNB 1001 sends a DL PHY signaling in DL control region to notify UE 1002 the slot type is DL-major. In addition, UE 1002 detects a DL scheduler and DL data in slot#3, while there is no scheduled UL control or data. As a result, UE 1002 knows that slot#3 is of DL-major slot type. In slot#4, eNB 1001 sends a DL PHY signaling in DL control region to notify UE 1002 the slot type is UL-major. In addition, there is no DL scheduler and DL data in slot#4, while there is scheduled UL control or data. As a result, UE 1002 knows that slot#4 is of UL-major slot type.

Note that there are different mechanisms for the physical layer signaling for slot type. One example is to have a separate physical-layer signaling for DL-only, DL-major & UL-major slot types only if this separate physical-layer signaling is a broadcasting/multicasting signaling and can only indicate the slot type for current slot. A second example is to have a unicast physical-layer signaling for all four slot types and it could be a new field in DL scheduler and UL grant to indicate the slot type for the scheduled slot. A third example is to have a unicast physical-layer signaling for all four slot types and it could be a new field in DL scheduler and UL grant to indicate the slot type for one or multiple slots, which may not include the current slot.

FIG. 10 is a flow chart of a method of dynamically configuring slot type with flexible frame structure from UE perspective in accordance with one novel aspect. In step 1001, a user equipment (UE) receives a higher layer configuration from a base station in a mobile communication network. The UE exchanges data with the base station according to a predefined radio frame format, and each radio frame comprises a plurality of slots. The higher layer configuration indicates which slots are downlink-only (DL-only) slots and which slots are flexible slots. In step 1002, the UE detects a physical layer signaling that indicates one or more slot types associated with corresponding one or more flexible slots of each radio frame. In step 1003, the UE determines the slot type of the flexible slots based on the higher layer configuration and the physical layer signaling.

FIG. 11 is a flow chart of a method of dynamically configuring slot type with flexible frame structure from eNB perspective in accordance with one novel aspect. In step 1101, a base station transmits a higher layer configuration to a user equipment (UE) in a mobile communication network. The base station exchanges data with the UE according to a predefined radio frame format, and each radio frame comprises a plurality of slots. The higher layer configuration indicates which slots are downlink-only (DL-only) slots and which slots are flexible slots. In step 1102, the base station transmits a physical layer signaling to indicate one or more slot types associated with corresponding one or more flexible slots of each radio frame. In step 1103, the base station performs data transmission and/or reception with the UE in the one or more flexible slots based on the indicated one or more slot type.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a higher layer configuration from a base station by a user equipment (UE) in a mobile communication network, wherein the UE exchanges data with the base station according to a predefined radio frame format, wherein each radio frame comprises a plurality of slots, and wherein the higher layer configuration indicates which slots are downlink-only (DL-only) slots and which slots are flexible slots;
detecting a physical layer signaling that indicates one or more slot types associated with corresponding one or more flexible slots of each radio frame; and
determining the one or more slot types of the one or more flexible slots based on the higher layer configuration and the physical layer signaling.

2. The method of claim 1, wherein each radio frame has a predefined time length, wherein each slot is a basic scheduling unit comprising a predefined number of OFDM symbols.

3. The method of claim 1, wherein a flexible slot has a flexible slot type that belongs to one of four predefined slot types comprising an all-downlink (DL-only) type, an all-uplink (UL-only) type, a DL-major type, and an UL-major type.

4. The method of claim 3, wherein a DL-only type slot comprises all DL OFDM symbols, an UL-only type slot comprises all UL OFDM symbols, a DL-major type slot comprises more DL OFDM symbols than UL OFDM symbols, an UL-major type slot comprises more UL OFDM symbols than DL OFDM symbols.

5. The method of claim 3, wherein the physical layer signaling comprises one bit indicating the flexible slot type is a unidirection slot type or a non-unidirection slot type.

6. The method of claim 3, wherein the physical layer signaling indicates whether the flexible slot type is a non-unidirection slot type.

7. The method of claim 3, wherein the physical layer signaling comprises one bit indicating the flexible slot type is DL-major or UL-major.

8. The method of claim 3, wherein the UE receives configuration information indicating a number of OFDM symbols reserved for guard period in DL-major slots or UL-major slots.

9. A user equipment (UE), comprising:
a receiver that receives a higher layer configuration from a base station by a user equipment (UE) in a mobile communication network, wherein the UE exchanges data with the base station according to a predefined radio frame format, wherein each radio frame comprises a plurality of slots, and wherein the higher layer configuration indicates which slots are downlink-only (DL-only) slots and which slots are flexible slots;
a detector that detects a physical layer signaling that indicates one or more slot types associated with corresponding one or more flexible slots of each radio frame; and
a slot configuration circuit that determines the one or more slot types of the one or more flexible slots based on the higher layer configuration and the physical layer signaling.

10. The UE of claim 9, wherein each radio frame has a predefined time length, wherein each slot is a basic scheduling unit comprising a predefined number of OFDM symbols.

11. The UE of claim 9, wherein a flexible slot has a flexible slot type belongs to one of four predefined slot types comprising an all-downlink (DL-only) type, an all-uplink (UL-only) type, a DL-major type, and an UL-major type.

12. The UE of claim 11, wherein a DL-only type slot comprises all DL OFDM symbols, an UL-only type slot comprises all UL OFDM symbols, a DL-major type slot comprises more DL OFDM symbols than UL OFDM symbols, an UL-major type slot comprises more UL OFDM symbols than DL OFDM symbols.

13. The method of claim 11, wherein the physical layer signaling comprises one bit indicating the flexible slot type is a unidirection slot type or a non-unidirection slot type.

14. The method of claim 11, wherein the physical layer signaling indicates whether the flexible slot type is a non-unidirection slot type.

15. The UE of claim 11, wherein the physical layer signaling comprises one bit indicating the flexible slot type is DL-major or UL-major.

16. The UE of claim 11, wherein the UE receives configuration information indicating a number of OFDM symbols reserved for guard period in DL-major slots or UL-major slots.

17. A method comprising:
transmitting a higher layer configuration from a base station to a user equipment (UE) in a mobile communication network, wherein the base station exchanges data with the UE according to a predefined radio frame format, wherein each radio frame comprises a plurality of slots, and wherein the higher layer configuration indicates which slots are downlink-only (DL-only) slots and which slots are flexible slots;
transmitting a physical layer signaling to indicate one or more slot types associated with corresponding one or more flexible slots of each radio frame; and
performing data transmission and/or reception with the UE in the one or more flexible slots based on the indicated one or more slot types.

18. The method of claim 17, wherein each radio frame has a predefined time length, wherein each slot is a basic scheduling unit comprising a predefined number of OFDM symbols.

19. The method of claim 17, wherein a flexible slot has a flexible slot type belongs to one of four predefined slot types comprising an all-downlink (DL-only) type, an all-uplink (UL-only) type, a DL-major type, and an UL-major type.

20. The method of claim 19, wherein the physical layer signaling indicates the flexible slot type is a unidirection slot type, a non-unidirection slot type, a DL-major slot type, or a UL-major slot type.

21. The method of claim 19, wherein the base station transmits configuration information indicating a number of OFDM symbols reserved for guard period in DL-major slots or UL-major slots.
